(19) United States
(12) Patent Application Publication
(10) Pub. No.: US 2015/0203004 A1
(43) Pub. Date: Jul. 23, 2015

(54) VEHICLE SEAT

(71) Applicant: Faurecia Autositze GmbH, Stadthagen (DE)

(72) Inventor: Christof Jan Sliwa, Schongau (DE)

(21) Appl. No.: 14/582,557

(22) Filed: Dec. 24, 2014

(30) Foreign Application Priority Data
Jan. 16, 2014 (DE) 102014000468.6

(51) Int. Cl. B60N 2/44; B60N 2/58

(52) U.S. Cl. CPC B60N 2/4415; B60N 2/58

(57) ABSTRACT

A vehicle seat has an adjustment device for adjusting a component of the vehicle seat. The adjustment device comprises at least one bladder that can be filled with fluid and one adjustment component. The bladder is arranged between the adjustment component and a counter section that is provided at the vehicle seat for support such that in the filled state it rests against the adjustment component and the counter section. The bladder is designed for the purpose of adjusting the adjustment component of the vehicle seat between two stop positions; a first stop position in which the bladder is filled minimally and a second stop position in which the bladder is filled maximally. Additionally provided is a pretensioning device, which acts upon the bladder such that during filling the bladder is filled against the pressure acting upon the bladder due to the pretension of the pretensioning device. The pretensioning device exerts a pretension on the bladder already at or in the area of the first stop position. The pretension is designed with such a magnitude that the pretension that acts against the bladder during filling due to the pressure of the adjustment component is greater than that required for retracting the adjustment component or such that the bladder rests against adjustment component and the counter section at or in the area of the first stop position without forming a curvature peak.

The invention relates to a vehicle seat according to the preamble of patent claim 1.

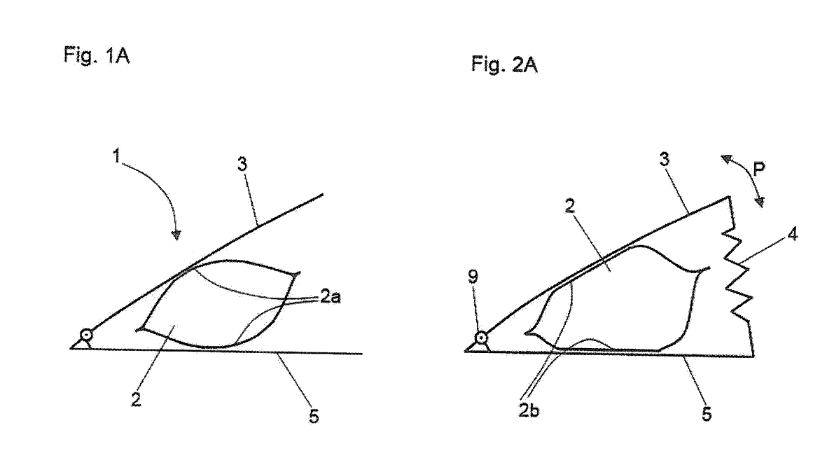

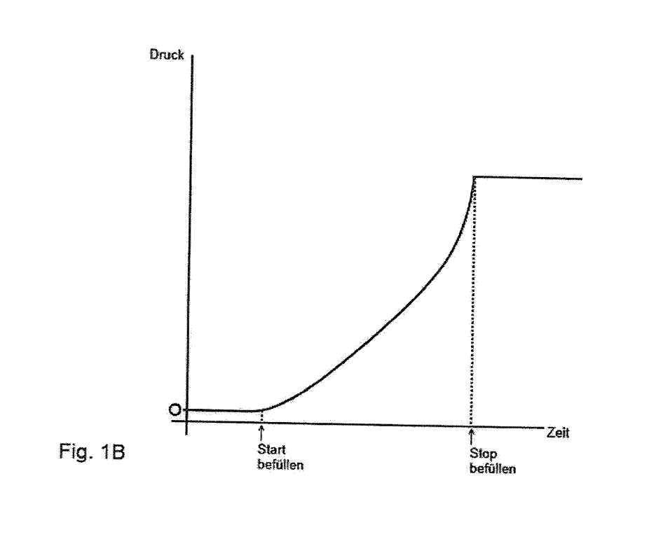

Respective vehicle seats having an adjustment device, are adjusted using a bladder that can be filled with a fluid, where an adjustment component can be moved in relation to the seat by the stroke generated by the filled bladder, and are already known from DE 10 2004 060 816 A1. There, an adjustment component of a head rest is moved using such a bladder in that the adjustment component 1 (cf. FIG. 1A) is pivoted between a first stop position (minimal stroke) and a second stop position (maximum stroke) by the bladder 2, which is supported on the rear side at a support component 5. To keep the movement reversible, as a rule, a return spring is provided, which is tensioned during the progression of the stroke path such that the adjustment component returns to the starting position upon full emptying of the bladder 2.

The adjustment of the known device is carried out very slowly during bladder filling as shown in FIG. 1B, because the pressure in the bladder rises only slowly. This means that large fill volumes are required for a noteworthy stroke (i.e., a “perceptible” adjustment), which slows down the response time significantly. In addition, if there is a heavy load on the adjustment component, the not fully filled bladder 2 is deformed elastically and relaxes again when the load is not present, such that the set position of the adjustment component changes (temporarily) (whiplash effect), which negatively influences the function of the respective seat section from a safety perspective.

The problem addressed by the present invention is, therefore, to provide a vehicle seat of the aforementioned kind, where these disadvantages do not occur.

This problem is solved by a vehicle seat with the features of claim 1. Advantageous embodiments are found in the dependent claims.

According to the invention, the adjustment component, or the bladder, respectively, must work against a relatively large force from the first stop position. For this purpose, the pretensioning device already exerts a pretension at or in the area of the first stop position. This pretension is designed with a magnitude such that the pretension that counteracts the bladder during filling due to the pressure of the adjustment component being greater than that required for retracting the adjustment component. Alternatively, it the bladder can rest at or in the area of the first stop position at the adjustment component and the counter section without forming a curvature peak.

In this manner, a high fill pressure is generated first relatively quickly in the bladder. The bladder is typically filled within about one second and the adjustment of the adjustment component starts. Quick pressurization is possible because the volume to be filled is very small due to the pretension at the start of the filling process mentioned above. When the pressure in the bladder is sufficiently high to overcome the pretension, a relatively large stroke of the bladder, and thus of the adjustment component, can be achieved by a relatively small pressure difference. Thus, the bladder is always filled relatively taut and forms a good counter support without too much of a bladder deformation. Undesirable influences through the described whiplash effect can thus be avoided.

The pretension, i.e., the force acting against filling, can be produced, for example, by a spring and/or tension in the seat cushion and/or tension in the seat cover and/or another feature and materials that have a spring effect such as rubber, for example. It is preferable if the (pretension) force acting against the bladder during filling is at least 50 N, preferably at least 100 N.

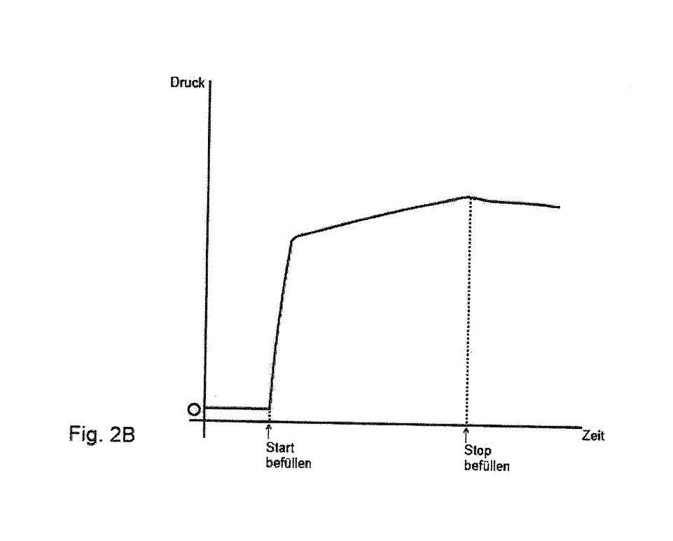

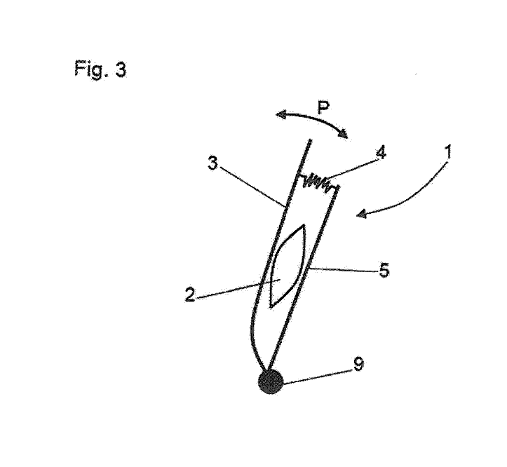

The invention will be explained in greater detail below based on FIGS. 2A to 3.

FIGS. 1A and 1B—show the embodiment of the prior art as discussed above.

FIG. 2A—shows schematically a sectional presentation of an adjustment device of a vehicle seat according to the invention.

FIG. 2B—shows the time progression of the bladder's filling procedure in the adjustment device of the vehicle seat according to the invention,

FIG. 3—shows another embodiment of the adjustment device of the vehicle seat according to the invention.

The adjustment devices 1 shown in exemplary fashion in FIGS. 2A and 3 have an adjustment component 3 and a counter section 5, which may be part of a vehicle seat according to the invention. The adjustment component 3 is preferably attached to the counter section 5 via a rotational or pivoting axis 9. In the shown example, a pretension is effective between the adjustment component 3 and the counter section 5, in particular at the section of the adjustment component 3, or the counter section 5, respectively, that is located opposite the rotational or pivoting axis 9, where said force can be realized, for example, as shown by a pretensioning device 4, in particular by a spring. A bladder 2 that can be filled with fluid is provided between the adjustment component 3 and the counter section 5 and its contact section 2b is resting at the adjustment component 3 and the counter section 5 according to the invention with an essentially large contact surface, i.e., without forming a curvature peak (cf. FIG. 1A). The pretension of the pretensioning device 4 is set accordingly such that no pronounced curvature peak (cf. Pos. 2a in FIG. 1A) is formed during bladder 2 filling but rather that an essentially flat contact of the bladder 2 is present. This effect can be enhanced further by the embodiment of FIG. 3 because there the adjustment component 3 has an approximately parallel contact section relative to the counter section 5. Through filling the bladder 2, or emptying it, respectively, the adjustment component 3 is pivoted or translated relative to the counter section 5 (cf. arrow P).

For example, it can be used to achieve seat adjustments in various areas of a vehicle seat, everywhere where adjustment devices are needed at the seat, for example at the lumbar adjustment, the adjustment of the side bolsters or for comfort adjustments of the seat portion, of a head or neck rest or the like. Thus, different settings for the vehicle occupant can be achieved by the stroke of the adjustment component.

Through the strong inventive spring load of the spring element 4 (which can be a spring but can also be realized through a respective spring load of the cushion or cover material, for example), which is preferably greater than 50 N, in particular 100 N or greater, the bladder 2 initially experiences a high pressure increase during filling—which can be seen in the diagram of FIG. 2B—because the fill medium (in particular air) has to work first against the spring load of the pretensioning device 4 until the pressure is sufficiently high to achieve a deflection of the pretensioning device, in particular of the spring 4. A continued pressure increase in the bladder 2 then leads to a stroke of the adjustment device, with only small pressure increases being sufficient to generate suitable adjustment strokes once the pretension load is compensated for by the existing pressure level. Accordingly, very quick adjustments of the adjustment component are possible (in both directions) and the bladder 2 has a high internal pressure and always rests solidly against the adjustment component 3 or the counter section 5, respectively. As a result, the system retreats only slightly through shocks and a whiplash effect through a large deformation of the bladder 2 is no longer possible.

1. Vehicle seat having an adjustment device (1) for adjusting a component (3) of the vehicle seat, wherein the adjustment device (1) comprises at least one bladder (2) that can be filled with fluid and an adjustment component (3), wherein the bladder (2) is arranged between the adjustment component (3) and the counter section (5) provided at the vehicle seat for support such that it rests in the filled state at the adjustment component (2[GW1]) and the counter section (5), and wherein the bladder (2) is designed for the purpose of adjusting the adjustment component (3) of the vehicle seat between two stop positions, a first stop position where the bladder (2) is filled minimally and a second stop position where the bladder (2) is filled maximally, wherein additionally a pretensioning device (4) is provided that acts upon the bladder (2) such that during filling the bladder (2) is filled against the pressure that acts upon the bladder due to the pretension of the pretensioning device (4), characterized in that the pretensioning device (4) exerts a pretension on the bladder (2) already at or in the area of the first stop position, wherein the pretension is designed to have a magnitude such that during filling the pretension that acts against the bladder (2) due to the pressure of the adjustment component is greater than is necessary for retracting the adjustment component (3) or in that the bladder (2) rests against the adjustment component (3) and the counter section (5) at or in the area of the first stop position without forming a curvature peak.

2. Vehicle seat as in claim 1, characterized in that the pretension is caused by a spring (6) and/or a tension in the seat cushion and/or a tension in the seat cover.

3. Vehicle seat as in one of the preceding claims, characterized in that during filling the pretension load acting against the bladder (2) is at least 50 N, preferably at least 100 N.
